(19) United States
(12) Patent Application Publication
(10) Pub. No.: US 2021/0248877 A1
(43) Pub. Date: Aug. 12, 2021

(54) HIGH-NUMBER CARD GAME WITH SPECIALTY TABLE SURFACE AND STRATEGIC METHOD OF BETTING

(71) Applicant: BC Innovations Inc., Hallandale, FL (US)

(72) Inventor: Brandon Colburn, Hallandale, FL (US)

(73) Assignee: BC Innovations Inc., Hallandale, FL (US)

(21) Appl. No.: 17/251,321

(22) PCT Filed: Feb. 28, 2019
(86) PCT No.: PCT/US2019/020166

§ 371 Date: Dec. 11, 2020

Related U.S. Application Data
(60) Provisional application No. 62/693,887, filed on Jul. 3, 2018.

(51) Int. Cl. G07F 17/32; A63F 1/06

(52) U.S. Cl. CPC G07F 17/3293; G07F 17/322; A63F 1/067

(57) ABSTRACT

A high-number card game with specialty table surface and method of betting requires players to pick a playing card that has a higher number than the dealer, such that the player's card competes only against the dealer's card, and the bigger card number wins; and if tied, the dealer wins. A card table provides a table surface defined by a card play portion for retaining the cards until displayed by the dealer; a primary bet portion where players place primary bets; and a bonus bet portion where players place bonus bets. The primary and bonus bet portions are disposed on table surface in an arcuate shape along the longitudinal direction. The primary bet portions are more proximal to the players than the bonus bet portions; and the primary bet portions are larger than the bonus bet portions, so as to encourage larger bets and minimize risk of card counting.

### CROSS-REFERENCE TO RELATED APPLICATION

This is a National stage filing of International Application No. PCT/US19/20166, filed Feb. 28, 2019, which claims priority to U.S. Provisional Patent Application No. 62/693,887, filed Jul. 3, 2018, the entirety of which is incorporated by reference.

### FIELD OF THE INVENTION

The present invention relates generally to table gaming assemblies and methods and, more particularly, relates to a high-number card game with specialty table surface and strategic method of betting.

### BACKGROUND OF THE INVENTION

Typically, games of chance employing a deck of 52 playing cards are often played as high/low card games, wherein players bet against other players, or a dealer, and win by drawing a card with a higher numbered or suit. High/low card games generally employ one or more cards which, when dealt upon a horizontal surface, determine a score based upon indicia displayed by the upwardly facing sides or faces of the resting cards when the cards are turned face up.

Such card games that utilize high-low wagering have an objective of betting that a player's card will be higher or lower than another player's or dealer's card. Often in a high-low card game, the payout, the odds of winning, and the betting options are limited. For example, the combination of cards from which the cards are drawn is limited to one deck. Or the wagering is limited to one bet per game.

Generally, high/low card games do not always incorporate side bets into the game. Or if allowed, the side bets are based on a player's or dealer's existing hand and therefore lack the drama and excitement involved in an additional game to determine whether the side bet pays off. Some exemplary side bets for card games, specifically Blackjack, involve providing a player an additional payout(s) based on the type of suit (e.g., spades, hearts, diamonds, rank (e.g., 9, 10, Jack, Queen), or combination of suit and rank of the dealer's and/or player's cards.

Therefore, a need exists to overcome the problems with the prior art as discussed above.

### SUMMARY OF THE INVENTION

The invention provides a high-number card game with specialty table surface and strategic method of betting that overcomes the hereinafore-mentioned disadvantages of the heretofore-known devices and methods of this general type and that has an objective for the player(s) to pick a playing card that has a higher number or value than that of the dealer, such that the player's card competes only against the card of the dealer. The playing card with the higher number or rank wins, and if there is a tie, the dealer wins.

The card game also provides a card table having an unconventional table surface. The table surface includes a card play portion for retaining the cards until flipped over and viewed by the players and dealer. The table surface is also defined by a primary bet portion where players place a primary bet, and a bonus bet portion where players place a bonus bet. The primary and bonus bet portions are arranged on the table surface in an arcuate shape along the longitudinal direction. This arcuate arrangement allows players on the left and right sides of the card table to be proximal to the bet portions, and thereby encourages larger betting by the players. The primary bet portions are more proximal to the players than the bonus bet portions, so as to encourage players to bet larger primary bets. The primary bet portions are larger than the bonus bet portions, so as to minimize the risk for card counting, since bonus bets are won with low numbered cards.

With the foregoing and other objects in view, there is provided, in accordance with the invention, a high-number card game with specialty table surface that comprises a card table used as the surface for playing the game and method. The card table is operably configured to be supported on a ground surface with at least one leg member. The card table has a rear side, a front side opposing the rear side, and a table surface that is generally flat, so as to support cards, betting portions, game card enclosures, and indicia necessary to play the card game. A sidewall forms a perimeter around the card table to prevent playing cards and bets from falling off the table. The table surface defines a plurality of player betting portions that correspond to a plurality of player seat positions on the card table. At least one of a plurality of players places the amount of the bet on a corresponding player betting portion. Each player betting portions is demarcated by at least one betting enclosure. The plurality of player betting portions are disposed proximal to the front side of the card table. The table surface also includes a card play portion used to retain the cards after being drawn. The card play portion is proximal to the rear side of the card table. The card play portion defines a plurality and series of longitudinally aligned, demarcated, and tightly spaced game card enclosures. Each game card enclosure has, respectively, a corresponding numerical value and indicia disposed at or proximal to each game card enclosure and increasing in value corresponding to the player seat position on the card table.

In accordance with another feature, an embodiment of the present invention further includes an enclosed sidewall defining, with the table surface, an enclosed game playing recess. The table surface is defined by the enclosed sidewall and is disposed in a substantially horizontal orientation with respect to the ground surface.

In accordance with a further feature of the present invention, the card table also includes a left side, a right side opposing the left side, and a longitudinal direction spanning from the left of the card table to the right side of the card table. The plurality of player betting portions are disposed on the table surface in an arcuate shape along the longitudinal direction.

In accordance with a further feature of the present invention, the plurality and series of longitudinally aligned demarcated game card enclosures are shaped and sized to correspond to an outer dimension of a playing card operably configured for use with the table surface.

In accordance with a further feature of the present invention, the plurality and series of longitudinally aligned demarcated game card enclosures are of a uniform height and width with respect to one another.

In accordance with a further feature of the present invention, the plurality of player betting portions include a primary bet portion and a bonus bet portion.

In accordance with a further feature of the present invention, the primary bet portion defines the area on the table surface for placing a primary bet.

In accordance with a further feature of the present invention, the bonus bet portion defines the area on the table surface for placing a bonus bet, whereby the bonus bet is placed subsequent to the primary bet. In accordance with a further feature of the present invention, the primary bet portion is more proximal to plurality of player seat positions than the bonus bet portion.

In accordance with a further feature of the present invention, the primary bet portion has larger dimensions than the bonus bet portion, whereby the at least one of a plurality of players has a larger area to place the primary bet.

In accordance with a further feature of the present invention, up to 30 percent of the plurality of player betting portions are disposed along the transverse length of the table surface in an arcuate shape along the longitudinal direction, whereby the at least one of the plurality of players have a generally uniform proximity to a corresponding plurality of player betting portions.

In accordance with the present invention, a method for strategic betting on a high-number card game initiates with a step of providing a card table with a table surface that defines a plurality and series of longitudinally aligned, demarcated, and tightly spaced game card enclosures each respectively having a corresponding numerical value and indicia disposed at or proximal to each game card enclosure and increasing in value corresponding to a plurality of player seat positions on the card table. The card table is operably configured to be supported on a ground surface with at least one leg member and having a rear side, a front side opposing the rear side.

The card table also defines a table surface defining: a primary bet portion defining an area on the table surface for placing a primary bet, a bonus bet portion defining an area on the table surface for placing a bonus bet, whereby the bonus bet is placed subsequent to the primary bet, the primary and bonus bet portions corresponding to the plurality of player seat positions on the card table and each demarcated by at least one betting enclosure, the plurality of player seat positions supporting at least one of a plurality of players.

The primary bet portion is more proximal to the plurality of player seat positions than the bonus bet portion, whereby the at least one of a plurality of players has more proximal access to place the primary bet, whereby the primary bet portion has larger dimensions than the bonus bet portion, and whereby the at least one of a plurality of players has a larger area to place the primary bet.

Further, up to 30% of the primary and bonus bet portions being disposed along the transverse length of the table surface in an arcuate shape along the longitudinal direction. The arcuate configuration brings the primary and bonus bet portions into proximity to the player seat positions. The table surface further includes a card play portion proximal to the rear side of the card table and defining a plurality and series of demarcated game card enclosures.

A step my include providing at last one deck of a plurality of playing cards each having a face displaying one of four suits and with an associated hierarchal rank associated therewith, the hierarchal rank including at least one of the following: a 2-card, a 3-card, a 4-card, a 5-card, a 6-card, a 7-card, a 8-card, a 9-card, a 10-card, a Jack card, a Queen card, a King card, an Ace card, and a Joker card.

The method may also include a step of initiating the card game and dealing, by a dealer, the at least one deck of playing cards, in an orientation facing the table surface, to the dealer and to the at least one of the plurality of players participating in the card game and within at least one of the plurality and series of longitudinally aligned, demarcated, and tightly spaced game card enclosures with the corresponding numerical value and indicia corresponding to the player seat position on the card table.

One step includes placing at least one primary bet from the at least one of a plurality of players associated with the plurality of player seat positions on the card table, the at least one primary bet corresponding to the at least one of a plurality of players participating in a card game utilizing the plurality of playing cards.

Another step comprises turning over the playing cards dealt to the dealer and the at least one of a plurality of players participating in the card game to reveal the hierarchal rank associated therewith.

Another step includes comparing the hierarchal rank for each of the playing cards dealt to the at least one of a plurality of players participating in the card game to the hierarchal rank for the playing card dealt to the dealer to ascertain a payout event, the payout event consisting of the hierarchal rank for each of the playing cards dealt to the at least one of a plurality of players participating in the card game exceeding the hierarchal rank for the playing card dealt to the dealer.

Another step includes annulling the payout event if the hierarchal rank for each of the playing cards dealt to the at least one of a plurality of players participating in the card game is equivalent to the hierarchal rank for the playing card dealt to the dealer.

In another embodiment, a step includes increasing the payout event to the at least one of the plurality of players to a 2 to 1 ratio if the playing cards dealt to the at least one of the plurality of players participating in the card game exceeds the hierarchal rank for the playing card dealt to the dealer, and if the hierarchal rank for the playing card dealt to the at least one of the plurality of players is the 3-card, the 4-card, or the 5-card.

An exemplary final step involves comparing the hierarchal rank for each of the playing cards dealt to the at least one of the plurality of players participating in the card game to the hierarchal rank for the playing card dealt to the dealer to ascertain a bonus payout event.

The bonus payout event to the players is at a ratio of 100 to 1 if the hierarchal rank for each of the playing cards dealt to the at least one of the plurality of players is the 3-card, and the hierarchal rank for each of the playing cards dealt to the dealer is the 2-card.

The bonus payout event to the players is at a ratio of 150 to 1 if the hierarchal rank for each of the playing cards dealt to the at least one of the plurality of players is the 3-card having a suit of Spades, and the hierarchal rank for each of the playing cards dealt to the dealer is the 2-card having a suit of Spades.

Although the invention is illustrated and described herein as embodied in a high-number card game with specialty table surface and strategic method of betting, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the card table.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a top view of a card table used for the high-number card game, in accordance with the present invention;

FIG. 2 is a flowchart for an exemplary strategic method of betting the high-number card game, in accordance with the present invention; and

FIG. 3 is a flowchart for a second embodiment of the strategic method of betting the high-number card game, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The invention described herein provides a gaming method utilizing playing cards that overcomes known disadvantages of those known devices and methods of this general type and that provides an enjoyable and mutually financially effective play method utilizing a modified and unconventional table layout. Although the invention is illustrated and described herein as embodied in a gaming method utilizing playing cards, it is, nevertheless, not intended to be limited to the details shown because various modifications and structural changes may be made therein without departing from the spirit of the invention. Additionally, well-known elements of exemplary embodiments of the invention will not be described in detail or will be omitted so as not to obscure the relevant details of the invention.

More specifically, a present invention relates to a multi-player high card gaming method that allows multiple players to compete against a dealer on, for example, a Blackjack-style table, with the objective of selecting the highest number or ranked card. The goal is for the player(s) to pick a card in the game that has a bigger number or value than that of the dealer. The player's card competes only against the card of the dealer. All the player's cards are all dealt face down, and then turned up by the dealer. The players with the bigger number or rank win. If there is a tie, the dealer wins.

Before the present invention is disclosed and described, it is to be understood that the terminology used herein is for the purpose of describing particular embodiments only and is not intended to be limiting.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The attached figures are incorporated in and form part of the specification, and serve to further illustrate various embodiments and explain various principles and advantages all in accordance with the present invention. Moreover, it is believed that the invention will be better understood from a consideration of the following description in conjunction with the drawing figures, in which like reference numerals are carried forward.

In one possible embodiment of the high-number card game 100 with specialty table surface and strategic method of betting, there is an objective for at least one of a plurality of players to pick a playing card that has a higher number than the dealer, such that the player's card competes only against the card of the dealer, and the bigger card number wins; and if tied, the dealer wins. The present invention also utilizes an unconventional card table 102 having supportive leg members 104a-d, an enclosed sidewall 130 for preventing playing cards and bets rom falling off the table surface 114, and a table surface 114 defined by a card play portion 126a-h for retaining the cards until displayed by the dealer.

The table surface 114 is also defined by a primary bet portion 118a-g where players place a primary bet 138, and a bonus bet portion 120a-n (wherein “n” represents any number greater than one) where players place a bonus bet 140. The primary and bonus bet portions 118a-g, 120a-n are disposed on the table surface 114 in an arcuate shape, extending along the longitudinal direction 116 of the table surface 114. This arcuate arrangement is unique in that the betting portions are disposed in a uniform proximity to all of the players—including players near the left and right sides 110, 112 of the card table 102. This uniform positioning of player betting portions can be useful for encouraging players to place more and larger bets.

Further, the primary bet portions 118a-g are more proximal to the player seat positions 122a-d than the bonus bet portions 120a-n. This works to encourage players to place larger primary bets. Further, the primary bet portions 118a-g are larger than the bonus bet portion 120a-n. This difference in distance to the players suggests to the players that the primary bet should be larger than the bonus bet. This works to reduce the risk of card counting, since the lower-numbered cards (2-card, 3-card) for the bonus bets.

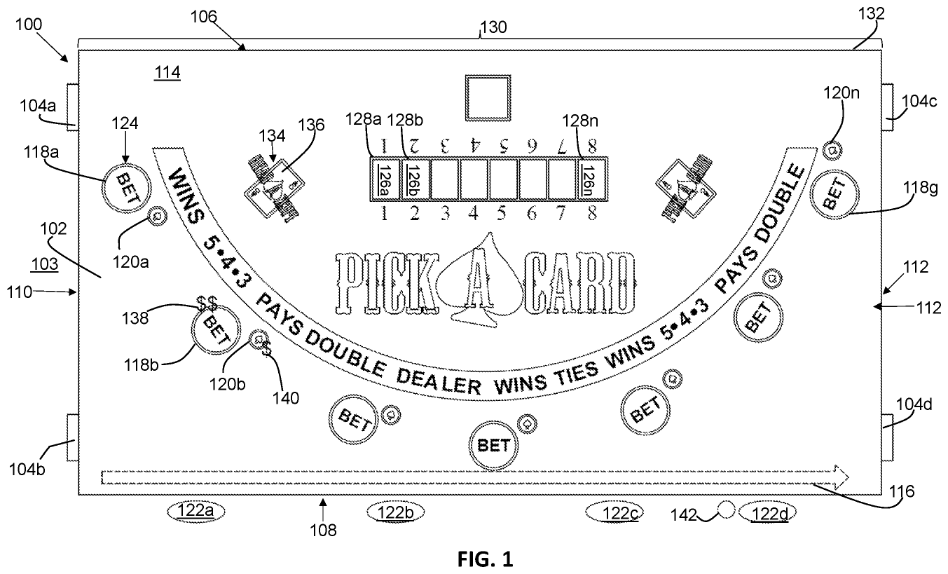

Referring now to FIG. 1, one embodiment of the present invention is shown in a top plan view. FIG. 1 shows several advantageous features of the present invention, but, as will be described below, the invention can be provided in several shapes, sizes, combinations of features and components, and varying numbers and functions of the components. The first example of a gaming method, as shown in FIG. 1, includes a physical card table 102 that includes a table surface 114 with a unique and unconventional layout associated with a base game utilizing the table surface 114 of the table 102. The table surface 114 may be surrounded by an enclosed sidewall 130 having an upper surface made of a deformable material acting as a cushion, e.g., a polymer layer encapsulating a fabric material, e.g., cotton. The table surface 114 may be of a felt material or other material known to those of skill in the art. The table surface 114 may be colored and patterned in a decorative manner to attract attention of players. Also, the table surface may be non-reflective of light so that the eyes of the players are comfortable while playing.

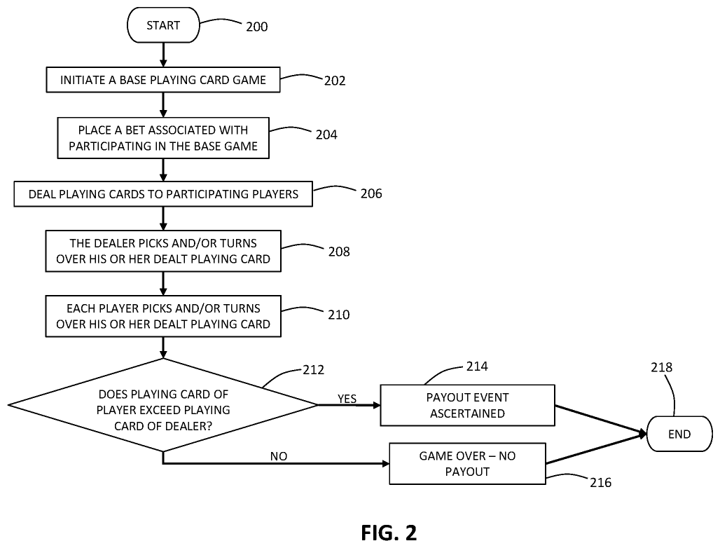

FIG. 1 will be described in conjunction with the process flow chart of FIG. 2. Although FIG. 2 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 2 for the sake of brevity. In some embodiments, some or all of the process steps included in FIG. 2 can be combined into a single process 200.

The process 200 starts at step 200 and immediately proceeds to step 202 of initiating a base card game 100 consisting of game play rules. The card game 100 may consist of playing cards 134, such as those known in the art of card playing games. In one embodiment, the gaming method described herein is carried out as part of a base game 100. In other embodiments, the gaming method described herein may be carried out as part of a side game 100 operable to initiated by a player/user through application of a secondary bet, wherein the side game 100 would also beneficially utilize the same playing cards as the base game 100. Either way, the gaming method is carried out in an unconventional and unique manner and configuration with respect to the table surface 114.

FIG. 1 depicts one exemplary game 100 layout. In other embodiments, the present invention may be carried out on another gaming table operable to be used with playing cards, an electronic processing assembly having a display, and the like. FIG. 1 shows several advantageous features of the card table 102, but, as will be described below, the card table 102 can be provided in several shapes, sizes, combinations of features and components, and varying numbers and functions of the components.

In one possible embodiment, the card table 102 is operably configured to be supported on a ground surface, e.g., surface 103, with one or more leg member(s) 104a-d. The leg members may include four equidistant legs that support the corners of a flat table surface 114. The table surface 114 is disposed in a substantially horizontal orientation with respect to the ground surface. The card table 102 is further defined by a rear side 106, a front side 108 opposing the rear side 106. The players align along the front side 108, while the dealer positons on the rear side 106 of the card table 102. The card table 102 may also have an enclosed sidewall 130 that defines, with the table surface 114, an enclosed game playing recess 132. The recess 132 and the sidewall 130 ensure that the bets and playing cards 134 do not fall off the table surface 114.

A table surface 114 overlays the card table 102. The table surface 114 may have a felt material and an ornamental color that attracts players and does not reflect light. The table surface 114 is defined by a plurality of player betting portions 118a-g, 120a-n. The player betting portions 118a-g, 120a-n define an area on the table surface 114 where each player places a primary bet 138, and a subsequent bonus bet 140. Such bets may include a poker chip, cash, a credit card, and other wagering media known in the art. The arcuate and proximal arrangement of the player betting portions 118a-g, 120a-n on the table surface 114, relative to the player seat positons 122a-d, helps encourage the players to place more and larger bets, while also minimizing card counting for bonus bets, as described below.

In one non-limiting embodiment, the player betting portions 118a-g, 120a-n are defined by a circular shape, indicia, and two different sizes. Each player betting portion is demarcated, or distinguished, by at least one betting enclosure, e.g., enclosure 124, that help contain or facilitate in keeping the bet inside the player betting portion. The betting enclosure can include a raised wall, or a depression in the table surface 114. In this manner, multiple players can segregate their bets, and bets cannot be knocked onto other areas of the table surface 114. The betting enclosure 124 may be completely enclosed or partially enclosed.

The player betting portions 118a-g, 120a-n correspond to a plurality of player seat positions 122a-d on the card table 102 where at least one of a plurality of players sits while playing the card game 100. In this seating arrangement, the player betting portions 118a-g, 120a-n are disposed adjacent and proximal to the front side 108 of the card table 102, within easy access to the players.

The proximal seating position and the unique arrangement of the player betting portions in relation to the players is designed to encourage the players to place larger and more bets. The arrangement also works to facilitate betting for the players, and highlights the primary bet over the bonus bet, so as to minimize the risk of card counting by the players.

For example, up to 30% of the player betting portions are disposed along the transverse length of the table surface 114, and in an arcuate shape along a longitudinal direction 116. This unique arcuate arrangement of player betting portions shortens the distance between the player seat positions 122a-d and the player betting portions. The resultant proximity between players and player betting portions 118a-g, 120a-n creates a psychological incentive to the players to place more and larger bets onto their respective player betting portion. Also, since the player is more proximal to the wager, i.e., chips, cash, credit card; and the betting enclosure 124 segregates the bet, the player has a greater sense of security knowing the bet is securely retained and only a short arm-distance away.

As FIG. 1 illustrates, the player betting portions include a primary bet portion 118a-g and a bonus bet portion 120a-n. The players initially place a primary bet 138 on the primary bet portion 118a-g directly in front of them. Then, after all the primary bets are placed, at least one of the plurality of players can place a bonus bet 140 in the bonus bet portion 120a-n. The primary bet portion 118a-g is larger, and more proximal to the players than the bonus bet portion 120a-n.

This size discrepancy between primary and bonus betting portions is designed to imply to the players that the primary bet should be larger than the bonus bet. This subtle highlighting of the primary bet portion can be useful for reducing card counting, since the bonus bet is played and won with low-numbered cards (2-card, and 3-card) where card counting is substantially easier. Conversely, the primary bet is played with the entire deck of playing cards 134, and further with up to 8 decks of playing cards from a shoe. Such a large amount of cards and high permutations/combinations can make it difficult to count cards.

Continuing, the card table 102 also comprises a card play portion 126a-h that is proximal to the rear side 106 of the card table 102; and thereby the dealer. The card play portion 126a-h is where the dealer places each player's card after drawing from the shoe, or other drawing means known in the art. The card play portion 126a-h is defined by a plurality and series of longitudinally aligned, demarcated, and tightly spaced game card enclosures 128a-n. Said another way, each of the enclosures may be directly adjacent and touching one another or within approximately 1-3 inches of one another. The game card enclosures 128a-n may be shaped and sized to correspond to an outer dimension 136 of a playing card 134 operably configured for use with the table surface 114. This may include a rectangular shape having dimensions of about 63.5 mm×88.9 mm.

Each game card enclosure 128 has a corresponding numerical value and indicia disposed at or proximal to each game card enclosure 128 and increasing in value corresponding to the player seat position on the card table 102. The indicia may be painted, etched, sewn, laminated into the table surface 114. For example, FIG. 1 illustrates the numbers 1-7 placed onto the card play portions 126a-n, with each number representing a player seat position. This organized means to retain the playing cards is effective for quick identification of the cards to their respective players.

The card table 102 is used to support playing cards and provide the layout that functions with the present invention, an electronic processing assembly with an electronic and/or digital display operable to display “representative playing cards” (i.e., a visual depiction of images emulating playing cards). The term “deck of playing cards,” without the modifier “representative,” is defined as physical cards having four suits (e.g., spades, hearts, diamonds, clubs), with each of the four suits having playing cards associated therewith of a varying rank (e.g., 2, 3, 4, etc.). In most embodiments, the deck of playing cards includes at least 52 playing cards with each Suit having 13 ranks associated therewith. Said playing cards may be located and/or covered in other areas of the table and/or dealt using various devices such as a shoe, electronic shoe, or a dispensing or shuffling device and/or by hand. Preferably, every shoe needs to be cut before being dealt. Also, if the dealer is changed in the middle of the shoe one card should be burned.

The present invention may be played by any number of players the card table 102 can reasonably hold. However, FIG. 1 depicts the present invention capable of engaging up to seven players at the same time. The base game 100 and gaming method may be played with six to eight decks of playing cards 134 based on, for example, the choice or desire of an administrator of the game 100, e.g., a Casino. Preferably, however, it is played with up to 7 decks.

In one embodiment, step 204 includes each player desiring to participate in the game 100 to place a bet before playing cards, i.e., a “hand,” is dealt. The player betting portions define an area where each player places a primary bet 138, and also has the option to place a bonus bet 140. The bets 138, 140 may include a poker chip, cash, credit card, and other wagering media known in the art. The players place the primary bet 138 on the primary bet portion 118a-g. Then, after all the primary bets are placed, at least one of the plurality of players can place a bonus bet in the bonus bet portion 120a-n.

As described below, the player wins the primary bet if the player draws a higher numbered card than the dealer. The player wins the bonus bet if the player draws a 3-card, and the dealer draws a lower numbered 2-card. In some embodiments, the players can win both bets 138, 140. However, in other embodiments, only one of the bets 138, 140 can be won by the players. If the player and dealer have identical card numbers, the dealer wins.

Next, step 206 may include dealing or passing out the cards to the respective players participating in the game. In preferred embodiments, players are not allowed to touch the cards. However, in other embodiments, the players may be permitted to touch the cards, but not allowed to turn over said cards. By dissuading the players from touching the cards, a greater sense of integrity is maintained in the high-number card game.

The next step 208 includes the dealer selecting and/or turning over his or her card. The dealer's card is always the first to be chosen, and the last to be turned over, after each player's card is turned over. Thereafter, step 210 includes the player(s) or dealer turning over and/or picking the player's card in one of the enclosures 106a-n. Players win by picking a higher card than the dealer. In one embodiment, the ace is the highest possible card that can be selected, with the “two” card being the lowest. Players will get paid and win if they have a card with a higher numerical or hierarchal value than the dealer's card. In one embodiment, a player wins with a 3-card, 4-card, or 5-card, they will get paid at 2 to 1.

Further, if there is a tie, the dealer may win. In one embodiment of the present invention, there is a “button 142” (or physical, electrical, and/or digital indicia) in the game dictating which player will pick the last card from one of the plurality and series of demarcated side game card enclosures, i.e., the player with the button 142 will pick the last card after every hand is dealt. The button 142 may move clockwise after every hand is over.

As such, using FIG. 1 as an example, after the dealer draws and deals the cards in front of him or her in the 8 side game card enclosures, each sequential player after the button picks their card. The dealer's card is always the last one to be chosen and the first to be flipped up. In one embodiment, the dealer will turn the players' cards over based on the designated number corresponding to the seat in each the player sits, one at a time from right to left, and pay or collect as necessary after each hand is flipped. In another embodiment, the dealer will turn each card of the players over based on the player's selection of the numerical designation corresponding to one of the plurality of enclosures, one at a time from right to left, and pay or collect as necessary after each hand is flipped.

In one embodiment, there is a “bonus bet 140” that pays at 100-to-1 if the player beats the dealer with a three-card. Said another way, to receive the bonus bet 140, the dealer must have a 2 and get beaten by a 3. Alternatively, if the player beats the dealer with a 3 of spades and the dealer's card is a 2 of spades, the player will get paid at 150-to-1.

In preferred betting environments, each of the players desiring to participate in the game must bet before the cards are dealt, the limit will be set up by the game administrator. If a player picks the higher number, then they win and may get paid 1-to-1. If the player wins with a 3, 4 or 5 gets paid 2-to-1. If the player bets the bonus bet and wins with a 3 over the dealer who must have a 2, the player gets paid 100-to-1. The game could be played on a blackjack-style table, but it has its own diagram and felt as well. For example, it also could be played in Baccarat-style table with higher limits if the game administrator chooses, in which it allows the players to touch the cards. In this case, cards must be retired after every shoe is dealt.

As such, a simple and fast new table game which is played at Blackjack-Style table, but it has its own diagram and felt as well. It may be hand-dealt or dealt from a shoe. Players begin by making a wager in a designated betting spot. The dealer deals out, face down as many cards as there are players (up to seven players at a time), plus one extra card for the dealer. The players, in turn, each pick the card they want and the dealer gets the last card. The playing cards are then turned face up, and a player wins if his or her card has a higher value than the dealer's card, but loses if there is a tie or if it is lower in value. If the player wins with a low card of 3, 4, or 5, he is paid at 2-to-1, whole other wins pay even money. Other pay tables, however, are possible.

In one payout example, there are 13 pay tables and all combinations of 1 through 8 decks. The recommended implementation is to use 6 decks and pay table number 4 (winning with 5 or less pays at 2-to-1), which has a House Edge of 3.834%. The Bonus Bet has a House Edge of 10.364% with 6 decks (it is the same whether the payout is 100-to-1 for all wins with a 3, or 150-to-1 for wins with 3 of spades over a 2 of spades).

For the recommended implementation, a card counting analysis was performed. The conclusion is that a card counting cannot gain any advantage in the main game. However, the Bonus Bet should be limited in size so that the advantage that can be gained from counting 2s and 3s cannot outweigh the House Edge of the main game. If the Bonus Bet is at most ½ of the main bet, the shoe may be dealt down to 3 decks left out of 6, or 2 decks left out of 6 if the bet size is not increased. If the Bonus Bet is at most ⅕ of the main bet, the shoe may be dealt down to 2 decks left out of 6, or 1 deck left out of 6 if the bet size is not increased. If the Bonus Bet is at most 1/10 of the main bet, the shoe may be dealt down to 1 deck left out of 6. If new players enter in the middle of the shoe and play the bonus bet, shuffling is recommended. The betting is described as a potentially optional wager placed in connection with a game and is generally considered a risk of against an outcome of a future event. This may include a sum of money represented with one or more chips or other indicia. In other embodiments, this may include other objects of value or points utilized in a point-scoring system.

Therefore, an unconventional card table and surface demarcation is utilized to function with the above-described method to derive a financially beneficial gaming method. Specifically, the table surface may have various portions associated with each player that is demarcated for the placement of a bet. Specifically, an unconventional table surface is provided in that the primary bet portion is more proximal to the player than the bonus bet portion. Also, the primary bet portion has larger dimensions than the bonus bet portion. This discrepancy in position and size between the primary and bonus betting portions is because the primary bet is mandatory for playing the game, and the primary bet is placed first; while the bonus bet is optional, and subsequent to the primary bet.

Furthermore, the bonus bet is smaller and more limited, as the bonus bet is won with lower numbered playing cards (2-card and 3-card). The reason for the limitations placed on the bonus bet is to help prevent card counting. By reducing the amount of the initial bet, the advantage from counting the 2-cards and the 3-cards is minimized. Thus, the bonus bet is allowed to be, at most, half of the primary bet, which requires a smaller area in the bonus bet portion to place the chips, money, etc.

Those skilled in the art will recognize that placing the bet portion more distally from the players, and in a smaller defined area conveys the message that the bonus bet is a less preferable option than the primary bet, and that the bonus bet is supposed to be smaller than the primary bet. By configuring the bonus bet portion to be smaller than the bonus bet portion, there is also less room to place the betting chips, cash, etc.

The table surface may have another portion, preferably proximal to the dealer position on the table, having a plurality and series of demarcated side game card enclosures. In FIG. 1, the table surface depicts 8 card enclosures of a rectangular shape substantially corresponding to the shape of an individual playing card. The enclosures may be depicted with a solid line or dashed line contrasting from a neighboring surface to indicate where a card is to be dealt.

In other embodiments, the enclosure may be circular, an oblong shape, or other polygonal shape that may correspond to the shape of the cards. Additionally, each enclosure may be directly adjacent to another, space apart from one another, or tightly spaced with respect to one another to effectively convey which card is associated with a player's seat. Beneficially, each enclosure preferably is labeled with a corresponding numeral corresponding to a player's position at the table.

After step 210 of turning over the playing cards in the plurality and series of demarcated side game card enclosures to reveal the hierarchal rank associated therewith, step 212 includes comparing the playing card of each player participating in the game to the playing card of the dealer to ascertain payout event.

As seen in step 214, the payout event includes the hierarchal rank of the playing card 134 of the player exceeding the hierarchal rank of the playing card of the dealer, i.e., the player wins. For example, the player has an 8-card and the dealer has a 5-card. If the hierarchal rank of the playing card of the player does not exceed the hierarchal rank of the playing card of the dealer, i.e., if the player has a card value that ties or is lesser in value than the dealer's card, he or she loses as seen in step 216. The process may terminate at step 218.

In an alternative embodiment of the present invention, a method 300 of playing the high-number card game takes advantage of the position and size of the player betting portions to encourage the players to increase the size and number of primary bets. The relative positon of the player seat positions to the player betting portions is one example of how placement results in larger bets.

As shown in FIG. 1, up to 30% of the player betting portions are disposed along the transverse length of the table surface in an arcuate shape along the longitudinal direction. This unique arcuate arrangement of player betting portions is effective for shortening the distance between the players and the player betting portions, as the players close to the left side 110 and right side 112 of the card table 102 are proximal to their respective player betting portions 118a-g, 120a-n. This proximity creates a psychological incentive to place more and larger bets; as the player is more proximal to the wager, i.e., chips, cash, etc.

The position and size of the player betting portions is also effective for minimizing the risk of card counting. This is because the bonus bet is placed with lower-numbered playing cards, i.e., the 2-card and the 3-card. The bonus bet is smaller and more limited, as the bonus bet requires greater odds for the players to win. Thus, the larger dimensions of the primary bet portion indicate in a subtle way that the primary bet should be larger than the bonus bet.

The reason for the limitations placed on the bonus bet is to help prevent card counting. By reducing the amount of the initial bet, the advantage from counting the 2-cards and the 3-cards is minimized. Thus, the bonus bet is allowed to be, at most, half of the primary bet, which requires a smaller area in the bonus bet portion to place the chips, money, etc.

Those skilled in the art will recognize that positioning the bonus bet portion more distally from the players, and in a smaller defined area on the table surface 114, implies to the players that the bonus bet should be smaller. By configuring the bonus bet portion 120a to be smaller than the primary bet portion 118a, the bonus bet portion also provides less space for placing the bet. This encourages a larger primary bet. Thus, the player betting portions on the table surface are uniquely configured to facilitate placing more and larger primary bets, while also minimizing card counting with the bonus bets, as described below.

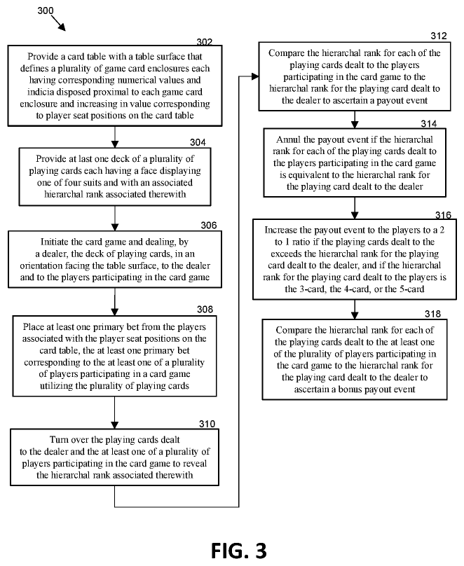

The flowchart process referenced in FIG. 3 references an alternative embodiment of a method 300 of strategically playing a high-number card game with specialty table surface. The method 300 teaches how the structure of the card table, and specifically the arrangement of the player betting portions, helps increase the size and quantity of the primary bet, while also reducing the risk of card counting by the players when placing the bonus bet.

The method 300 initiates with a step 302 of providing a card table with a table surface that defines a plurality and series of longitudinally aligned, demarcated, and tightly spaced game card enclosures each respectively having a corresponding numerical value and indicia disposed at or proximal to each game card enclosure and increasing in value corresponding to a plurality of player seat positions on the card table. As discussed above, the card table is operably configured to be supported on a ground surface with at least one leg member and having a rear side, a front side opposing the rear side.

The card table also defines a table surface comprising a primary bet portion that defines an area on the table surface for placing a primary bet. The table surface further includes a bonus bet portion that defines an area on the table surface for placing a bonus bet. The primary bet portion may be a larger circular demarcation, wall, or depression than that represented by the bonus bet portion. The bonus bet portion may have the same circular shape, but with a smaller diameter (FIG. 1).

The primary and bonus bet portions correspond to a plurality of player seat positions on the card table and each demarcated by at least one betting enclosure. The plurality of player seat positions may representative a position of a player on the table and/or where the player is supported for game play. The player seat positions may include at least one of a plurality of players in a uniform arrangement along the front side of the card table. In this manner, the card game is scalable, and can be played by one or more players, depending on the size of the card table.

As depicted in FIG. 1, the primary bet portion is more proximal to the player seat positions than the bonus bet portion. This proximity is possible because up to 30% of the primary and bonus bet portions are disposed along the transverse length of the table surface in an arcuate shape along the longitudinal direction. The arcuate configuration positions the primary bet portions into a more proximal position relative to the player seat positions. The table surface further includes a card play portion where the playing cards are retained after being drawn, and flipped over by the dealer. The card playing portion is directly in front of the dealer, proximal to the rear side of the card table. The card play portion is defined by a plurality and series of demarcated game card enclosures.

A step 304 my include providing at last one deck of a plurality of playing cards each having a face displaying one of four Suits and with an associated hierarchal rank associated therewith. In one embodiment, the hierarchal rank including at least one of the following: a 2-card, a 3-card, a 4-card, a 5-card, a 6-card, a 7-card, a 8-card, a 9-card, a 10-card, a Jack card, a Queen card, a King card, an Ace card, and a Joker card. Different Suits of playing cards may also be used for determining the winner. Nonetheless, the higher numbered playing card is always the winner between the players and the dealer.

The method 300 may also include a step 306 of initiating the card game and dealing, by a dealer, the at least one deck of playing cards, in an orientation facing the table surface, to the dealer and to the at least one of the plurality of players participating in the card game and within at least one of the plurality and series of longitudinally aligned, demarcated, and tightly spaced game card enclosures with the corresponding numerical value and indicia corresponding to the player seat position on the card table.

As such, using FIG. 1 as an example, after the dealer draws and deals the cards in front of him or her in the 8 side game card enclosures, each sequential player after the button picks their card. The dealer's card is always the last one to be chosen and the first to be flipped up.

In one embodiment of the present invention, the card game provides a “button” (or physical, electrical, and/or digital indicia) in the game dictating which player will pick the last card from one of the plurality and series of demarcated side game card enclosures, i.e., the player with the button will pick the last card after every hand is dealt. The button may move clockwise after every hand is over.

In one embodiment, the dealer will turn the players' cards over based on the designated number corresponding to the seat in each the player sits, one at a time from right to left, and pay or collect as necessary after each hand is flipped. In another embodiment, the dealer will turn each card of the players over based on the player's selection of the numerical designation corresponding to one of the plurality of enclosures, one at a time from right to left, and pay or collect as necessary after each hand is flipped.

A step 308 includes placing at least one primary bet from the at least one of a plurality of players associated with the plurality of player seat positions on the card table, the at least one primary bet corresponding to the at least one of a plurality of players participating in a card game utilizing the plurality of playing cards. As discussed above, up to 30% of the player betting portions are disposed along the transverse length of the table surface in an arcuate shape along the longitudinal direction. This positions the bet portions near the players on the left and right sides of the card table.

This unique arcuate arrangement of player betting portions is effective for shortening the distance between the players and the player betting portions, as the players close to the left side and right side of the card table are proximal to their respective player betting portions. This proximity creates a psychological incentive to place more and larger bets; as the player is more proximal to the wager, i.e., chips, cash, etc.

In some embodiments, the method 300 may include a step 310 of turning over the playing cards 134 dealt to the dealer and the at least one of a plurality of players participating in the card game to reveal the hierarchal rank associated therewith. The dealer is the only entity in the game that can tough the playing cards. However, in alternative embodiments, the players may be permitted to touch the cards, but not allowed to turn over said cards. By dissuading the players from touching the cards, a greater sense of integrity is maintained in the high-number card game.

A step 312 comprises comparing the hierarchal rank for each of the playing cards dealt to the at least one of a plurality of players participating in the card game to the hierarchal rank for the playing card dealt to the dealer to ascertain a payout event, the payout event consisting of the hierarchal rank for each of the playing cards dealt to the at least one of a plurality of players participating in the card game exceeding the hierarchal rank for the playing card dealt to the dealer.

Another step 314 includes annulling the payout event if the hierarchal rank for each of the playing cards dealt to the at least one of a plurality of players participating in the card game is equivalent to the hierarchal rank for the playing card dealt to the dealer. Thus, if the player has a 10-card and the dealer has a 10-card of a different Suit, the dealer wins based on the number of the card. This tie scenario provides an advantage to the dealer, further increasing the odds for the players to win.

A step 316 includes increasing the payout event to the at least one of the plurality of players to a 2 to 1 ratio if the playing cards dealt to the at least one of the plurality of players participating in the card game exceeds the hierarchal rank for the playing card dealt to the dealer, and if the hierarchal rank for the playing card dealt to the at least one of the plurality of players is the 3-card, the 4-card, or the 5-card.

A final step 318 involves comparing the hierarchal rank for each of the playing cards dealt to the at least one of the plurality of players participating in the card game to the hierarchal rank for the playing card dealt to the dealer to ascertain a bonus payout event. The bonus payout event requires greater odds for the players to win, but the payout is greater.

The bonus payout event to the players is at a ratio of 100 to 1 if the hierarchal rank for each of the playing cards dealt to the players is the 3-card, and the hierarchal rank for each of the playing cards dealt to the dealer is the 2-card. In another possible bonus payout configuration, the bonus payout event to the players is at a ratio of 150 to 1 if the hierarchal rank for each of the playing cards dealt to the players is the 3-card having a suit of Spades, and the hierarchal rank for each of the playing cards dealt to the dealer is the 2-card having a suit of Spades.

What is claimed is:

1. A high-number card game with specialty table surface comprising:
a card table operably configured to be supported on a ground surface with at least one leg member and having a rear side, a front side opposing the rear side, and a table surface defining:
a plurality of player betting portions corresponding to a plurality of player seat positions on the card table and each demarcated by at least one betting enclosure, at least one of the plurality of player betting portions disposed proximal to the front side of the card table; and
a card play portion proximal to the rear side of the card table and defining a plurality and series of longitudinally aligned, demarcated, and tightly spaced game card enclosures each respectively having a corresponding numerical value and indicia disposed at or proximal to each game card enclosure and increasing in value corresponding to the player seat position on the card table.

2. The card game system with specialty table surface according to claim 1, wherein the card table further comprises:
an enclosed sidewall defining, with the table surface, an enclosed game playing recess, wherein the table surface is defined by the enclosed sidewall and is disposed in a substantially horizontal orientation with respect to the ground surface.

3. The card game system with specialty table surface according to claim 1, wherein the card table further comprises:
a left side, a right side opposing the left side, and a longitudinal direction spanning from the left of the card table to the right side of the card table, wherein the plurality of player betting portions are disposed on the table surface in an arcuate shape along the longitudinal direction.

4. The card game system with specialty table surface according to claim 1, wherein:
the plurality and series of longitudinally aligned demarcated game card enclosures are shaped and sized to correspond to an outer dimension of a playing card operably configured for use with the table surface.

5. The card game system with specialty table surface according to claim 1, wherein:
the plurality and series of longitudinally aligned demarcated game card enclosures are of a uniform height and width with respect to one another.

6. The card game system with specialty table surface according to claim 1, wherein:
the plurality of player betting portions include a primary bet portion and a bonus bet portion.

7. The card game system with specialty table surface according to claim 6, wherein:
the primary bet portion defines the area on the table surface for placing a primary bet.

8. The card game system with specialty table surface according to claim 7, wherein:
the bonus bet portion defines the area on the table surface for placing a bonus bet, whereby the bonus bet is placed subsequent to the primary bet.

9. The card game system with specialty table surface according to claim 8, wherein:
the primary bet portion is more proximal to plurality of player seat positions than the bonus bet portion.

10. The card game system with specialty table surface according to claim 9, wherein:
the primary bet portion has larger dimensions than the bonus bet portion, whereby the at least one of a plurality of players has a larger area to place the primary bet.

11. The card game system with specialty table surface according to claim 10, wherein:
up to 30 percent of the plurality of player betting portions are disposed along the transverse length of the table surface in an arcuate shape along the longitudinal direction, whereby the at least one of the plurality of players have a generally uniform proximity to a corresponding plurality of player betting portions.

12. The card game system with specialty table surface according to claim 10, further comprising:
a button, the button being passed between the at least one of the plurality of players, the button signifying the last player to receive the playing card in the respective card play portion.

13. A method of playing a high-number card game with specialty table surface comprising the steps of:
providing a card table with a table surface that defines a plurality and series of longitudinally aligned, demarcated, and tightly spaced game card enclosures each respectively having a corresponding numerical value and indicia disposed at or proximal to each game card enclosure and increasing in value corresponding to a player seat position on the card table, the card table having a table surface defining:
a plurality of player betting portions corresponding to the plurality of player seat positions on the card table and each demarcated by at least one betting enclosure, at least one of the plurality of player betting portions disposed proximal to the front side of the card table,
up to 30 percent of the plurality of player betting portions being disposed along the transverse length of the table surface in an arcuate shape along the longitudinal direction, whereby the arcuate configuration brings into proximity to the player seat positions; and whereby the player seat positions have a generally uniform proximity to corresponding player betting portions;
a card play portion proximal to the rear side of the card table and defining a plurality and series of demarcated game card enclosures;
providing at last one deck of a plurality of playing cards each having a face displaying one of four suits and with an associated hierarchal rank associated therewith;
initiating the card game and dealing, by a dealer, the at least one deck of playing cards, in an orientation facing the table surface, to the dealer and to the at least one of the plurality of players participating in the card game and within at least one of the plurality and series of longitudinally aligned, demarcated, and tightly spaced game card enclosures with the corresponding numerical value and indicia corresponding to the player seat position on the card table;
placing at least one primary bet from the at least one of a plurality of players associated with the plurality of player seat positions on the card table, the at least one primary bet corresponding to the at least one of a plurality of players participating in a card game utilizing the plurality of playing cards;
initiating the card game and dealing, by a dealer, the at least one deck of playing cards, in an orientation facing the table surface, to the dealer and to the at least one of a plurality of players participating in the card game and within at least one of the plurality and series of demarcated game card enclosures;
turning over the playing cards dealt to the dealer and the at least one of a plurality of players participating in the card game to reveal the hierarchal rank associated therewith;
comparing the hierarchal rank for each of the playing cards dealt to the at least one of a plurality of players participating in the card game to the hierarchal rank for the playing card dealt to the dealer to ascertain a payout event, the payout event consisting of the hierarchal rank for each of the playing cards dealt to the at least one of a plurality of players participating in the card game exceeding the hierarchal rank for the playing card dealt to the dealer; and
annulling the payout event if the hierarchal rank for each of the playing cards dealt to the at least one of a plurality of players participating in the card game is equivalent to the hierarchal rank for the playing card dealt to the dealer.

14. The method according to claim 13, wherein:
the plurality of player betting portions include a primary bet portion and a bonus bet portion, the primary bet portion being more proximal to the plurality of player seat positions than the bonus bet portion, whereby the at least one of a plurality of players has more proximal access to place the primary bet, the primary bet portion having larger dimensions than the bonus bet portion, whereby the at least one of a plurality of players has a larger area to place the primary bet.

15. The method according to claim 13, wherein:
the hierarchal rank for the playing cards comprises a 2-card, a 3-card, a 4-card, a 5-card, a 6-card, a 7-card, a 8-card, a 9-card, a 10-card, a Jack card, a Queen card, a King card, an Ace card, and a Joker card.

16. The method according to claim 15, further comprising:
increasing the payout event to the at least one of a plurality of players to a 2 to 1 ratio if the playing cards dealt to the at least one of a plurality of players participating in the card game exceeds the hierarchal rank for the playing card dealt to the dealer, and if the hierarchal rank for the playing card dealt to the at least one of a plurality of players is the 3-card, the 4-card, or the 5-card.

17. The method according to claim 13, further comprising:
placing at least one bonus bet from at least one of the plurality of players associated with the plurality of player seat positions on the card table, the at least one bonus bet corresponding to the at least one of a plurality of players participating in the card game.

18. The method according to claim 17, further comprising:
comparing the hierarchal rank for each of the playing cards dealt to the at least one of the plurality of players participating in the card game to the hierarchal rank for the playing card dealt to the dealer to ascertain a bonus payout event.

19. The method according to claim 18, wherein:
the bonus payout event to the players is at a ratio of 100 to 1 if the hierarchal rank for each of the playing cards dealt to the at least one of the plurality of players is the 3-card, and the hierarchal rank for each of the playing cards dealt to the dealer is the 2-card, and further the bonus payout event to the players is at a ratio of 150 to 1 if the hierarchal rank for each of the playing cards dealt to the at least one of a plurality of players is the 3-card having a suit of Spades, and the hierarchal rank for each of the playing cards dealt to the dealer is the 2-card having a suit of Spades.

20. A method of playing a high-number card game with specialty table surface comprising the steps of:
providing a card table with a table surface that defines a plurality and series of longitudinally aligned, demarcated, and tightly spaced game card enclosures each respectively having a corresponding numerical value and indicia disposed at or proximal to each game card enclosure and increasing in value corresponding to a plurality of player seat positions on the card table, the card table being operably configured to be supported on a ground surface with at least one leg member and having a rear side, a front side opposing the rear side, and a table surface defining:
a primary bet portion defining an area on the table surface for placing a primary bet,
a bonus bet portion defining an area on the table surface for placing a bonus bet, whereby the bonus bet is placed subsequent to the primary bet,
the primary and bonus bet portions corresponding to the plurality of player seat positions on the card table and each demarcated by at least one betting enclosure, the plurality of player seat positions supporting at least one of a plurality of players,
the primary bet portion being more proximal to the plurality of player seat positions than the bonus bet portion, whereby the at least one of a plurality of players has more proximal access to the primary bet portion to place the primary bet,
whereby the primary bet portion has larger dimensions than the bonus bet portion, whereby the at least one of a plurality of players has a larger area to place the primary bet,
up to 30 percent of the primary and bonus bet portions being disposed along the transverse length of the table surface in an arcuate shape along the longitudinal direction, whereby the arcuate configuration forms a generally uniform proximity between the player seat positions and the corresponding plurality of player betting portions; and
a card play portion proximal to the rear side of the card table and defining a plurality and series of demarcated game card enclosures;
providing at last one deck of a plurality of playing cards each having a face displaying one of four suits and with an associated hierarchal rank associated therewith, the hierarchal rank including at least one of the following: a 2-card, a 3-card, a 4-card, a 5-card, a 6-card, a 7-card, a 8-card, a 9-card, a 10-card, a Jack card, a Queen card, a King card, an Ace card, and a Joker card;
initiating the card game and dealing, by a dealer, the at least one deck of playing cards, in an orientation facing the table surface, to the dealer and to the at least one of the plurality of players participating in the card game and within at least one of the plurality and series of longitudinally aligned, demarcated, and tightly spaced game card enclosures with the corresponding numerical value and indicia corresponding to the player seat position on the card table;
placing at least one primary bet from the at least one of a plurality of players associated with the plurality of player seat positions on the card table, the at least one primary bet corresponding to the at least one of a plurality of players participating in a card game utilizing the plurality of playing cards;
turning over the playing cards dealt to the dealer and the at least one of a plurality of players participating in the card game to reveal the hierarchal rank associated therewith;
comparing the hierarchal rank for each of the playing cards dealt to the at least one of a plurality of players participating in the card game to the hierarchal rank for the playing card dealt to the dealer to ascertain a payout event, the payout event consisting of the hierarchal rank for each of the playing cards dealt to the at least one of a plurality of players participating in the card game exceeding the hierarchal rank for the playing card dealt to the dealer;
annulling the payout event if the hierarchal rank for each of the playing cards dealt to the at least one of a plurality of players participating in the card game is equivalent to the hierarchal rank for the playing card dealt to the dealer;
increasing the payout event to the at least one of the plurality of players to a 2 to 1 ratio if the playing cards dealt to the at least one of the plurality of players participating in the card game exceeds the hierarchal rank for the playing card dealt to the dealer, and if the hierarchal rank for the playing card dealt to the at least one of the plurality of players is the 3-card, the 4-card, or the 5-card; and
comparing the hierarchal rank for each of the playing cards dealt to the at least one of the plurality of players participating in the card game to the hierarchal rank for the playing card dealt to the dealer to ascertain a bonus payout event,
whereby the bonus payout event to the players is at a ratio of 100 to 1 if the hierarchal rank for each of the playing cards dealt to the at least one of the plurality of players is the 3-card, and the hierarchal rank for each of the playing cards dealt to the dealer is the 2-card,
whereby the bonus payout event to the players is at a ratio of 150 to 1 if the hierarchal rank for each of the playing cards dealt to the at least one of the plurality of players is the 3-card having a suit of Spades, and the hierarchal rank for each of the playing cards dealt to the dealer is the 2-card having a suit of Spades.
